(19) United States
(12) Patent Application Publication
(10) Pub. No.: US 2021/0018950 A1
(43) Pub. Date: Jan. 21, 2021

(54) HANDLE ATTACHMENT SYSTEMS AND METHOD

(71) Applicant: Mitzi Cooper, Jonesborough, TN (US)

(72) Inventor: Mitzi Cooper, Jonesborough, TN (US)

(21) Appl. No.: 16/776,245

(22) Filed: Jan. 29, 2020

Related U.S. Application Data
(60) Provisional application No. 62/874,006, filed on Jul. 15, 2019.

(51) Int. Cl. G05G 1/12; F16K 31/60

(52) U.S. Cl. CPC G05G 1/12; F16K 31/60

(57) ABSTRACT

A handle attachment for water faucets designed to offer a firm grip when turning the faucet. It features an ergonomic, rectangular shape that can be easily grasped with one hand to turn the faucet left or right. It attaches conveniently to the rounded faucet via at least two zip ties. It prevents hand injuries that may occur from having to directly grab the faucet that can be covered in metallic burrs or broken parts, rust, and the like. It offers a way for physically limited individuals to easily activate their water faucets.

### CROSS-REFERENCE TO RELATED APPLICATION(S)

The present application is related to and claims priority to U.S. Provisional Patent Application No. 62/874,006 filed Jul. 15, 2019, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of valves and valve actuation of existing art and more specifically relates to rotary valves and valve actuation.

### RELATED ART

Outdoor water faucets commonly comprise a small, round activation handle. The round handle can be difficult to grip, especially for those with limited physical dexterity. Some handles can become rusted while outdoors and may be even more difficult to turn. Replacing the handle may be the only current option. A suitable solution is desired.

U.S. Pat. No. 4,961,443 to Dana F. Buccicone et al. relates to a handle assembly. The described handle assembly is attachable to a conventional valve stem and includes a decorative handle member. In a preferred embodiment, an adapter element has an interior splined surface that mounts on the valve stem. The adapter also includes external splines and an annular flange. The adapter is positioned within a central opening in an escutcheon. A mounting screw fastens the adapter to the valve stem, with the escutcheon trapped beneath the adapter due to the presence of the annular flange. A post member has internal splines which engage the external splines of the adapter so that the parts rotate together. In addition, the post member has external splines which engage a splined opening in a handle. The handle comprises a bottom lever bar and a top lever bar. A strap cap is positioned over the handle and has a threaded hole to receive an upwardly-directed bolt. The bolt presses the handle between the strap cap and the post member. In the final assembly step, a threaded surface on the escutcheon is rotatively engaged with a threaded surface on the post member, thereby pressing the adapter element between the escutcheon and the post member.

### SUMMARY OF THE INVENTION

In view of the foregoing disadvantages inherent in the known valves and valve actuations art, the present disclosure provides a novel handle attachment system. The general purpose of the present disclosure, which will be described subsequently in greater detail, is to provide efficient and effective means to turn rotary valve handles.

A handle attachment system is disclosed herein, the system in a preferred embodiment comprising: a handle having (defined by) a body with a length; a thickness; a width; and a plurality of apertures; and an attacher (preferably zip-tie or other suitably equivalent attachment means); wherein the handle and the attacher are able to be removably attachable to a rotary valve handle to facilitate ease of manipulation of the rotary valve handle between open and closed conditions. The attacher comprises two of the attacher in preferred embodiments. The attacher preferably comprises teeth, a cable, a head with a pawl; the pawl designed to engage with the teeth to create a fixed positioning. A first attacher is coupled to a left side of a rotary valve handle and another attacher is attached to a right side of the rotary valve handle through respective apertures then rotated clockwise and alternately counter-clockwise by the user. The attacher preferably comprises flexible material. The attacher is able to be fed through a corresponding one of the plurality of apertures to engage with the rotary valve handle such that the body is able to rotationally manipulate and leverage the rotary valve handle via the length of the body.

The handle comprises a bar; wherein the bar is substantially rectangular with rounded ends and the length of the bar is greater than a diameter of the rotary valve handle such that when hand-gripping the user is able to be accomplish a grip on both ends of the bar outside of the diameter of the rotary valve handle. As such, the bar is useful as a lever in relation to the rotary valve handle; wherein the lever preferably comprises a mass greater than that of the rotary valve handle and the lever is parallel to the rotary valve handle when used. A kit is also described for sale and for use.

A method of use for the handle attachment system is also described, the method comprising the steps of: providing a handle attachment system, (the system comprising: a handle having a body with a length; a thickness; a width; and a plurality of apertures; and an attacher); inserting the attacher through a respective the aperture; removably coupling the body to a rotary valve handle; and leveraging movement of the rotary valve handle via hand-manipulation of the body of the handle; wherein the leveraging movement is able to be done in clockwise and alternately counter-clockwise directions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a handle attachment system, constructed and operative according to the teachings of the present disclosure.

FIG. 1 is a perspective view of the handle attachment system, according to an embodiment of the disclosure.

FIG. 2 is a perspective view of the handle attachment system during an in-use condition of FIG. 1, according to an embodiment of the present disclosure.

FIG. 3 is a perspective view of the handle attachment system of FIG. 1, according to an embodiment of the present disclosure.

FIG. 4 is a perspective view of the handle attachment system of FIG. 1, according to an embodiment of the present disclosure.

FIG. 5 is a perspective view of the handle attachment system, in a ready-for-use condition, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a valve attachment means and more particularly to a handle attachment system as used to improve the use and longevity of rotary handle valves.

Generally, the handle is a modified handle attachment for a water faucet. The device can be attached directly to the faucet's existing handle, functioning as a more convenient method to turn the faucet on or off. The handle can comprise a rectangular unit with a pair of threaded apertures on each end.

The apertures are designed to accommodate two zip ties or other suitable attaching means. The zip ties can be used to securely attach the handle to the existing faucet. Users can thread the zip ties through the handle attachment and then around the existing round faucet. The zip ties are then secured, effectively securing the handle attachment. The rectangular surface offers an ergonomic grip, making it much easier to turn the existing faucet handle.

Handle can be constructed using plastic, wood, metal, and other suitable materials. Exact size, measurement, construction, and design specifications may vary upon further development and manufacturing.

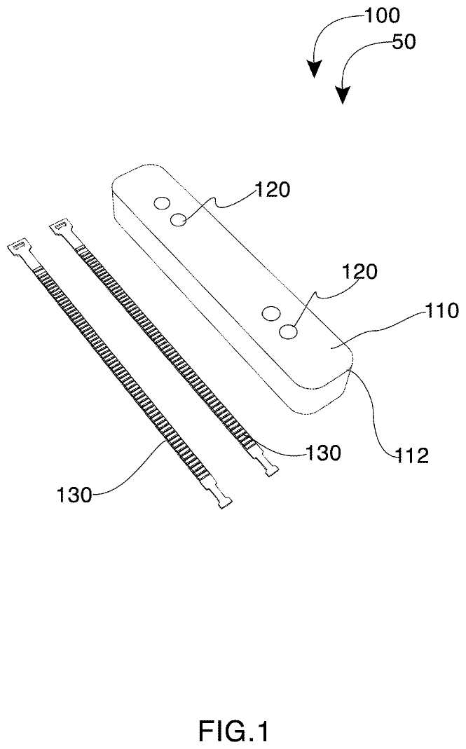

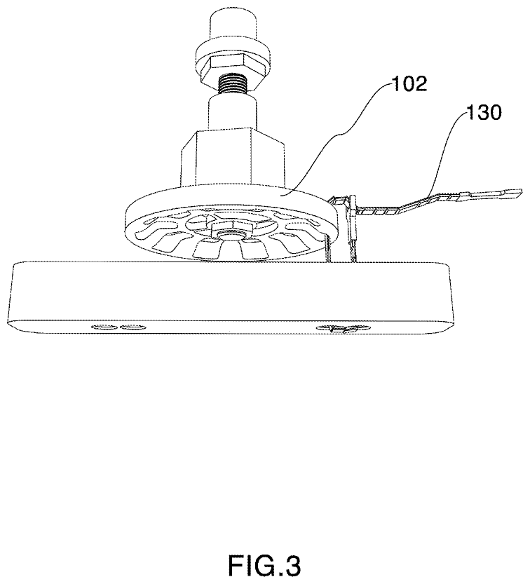

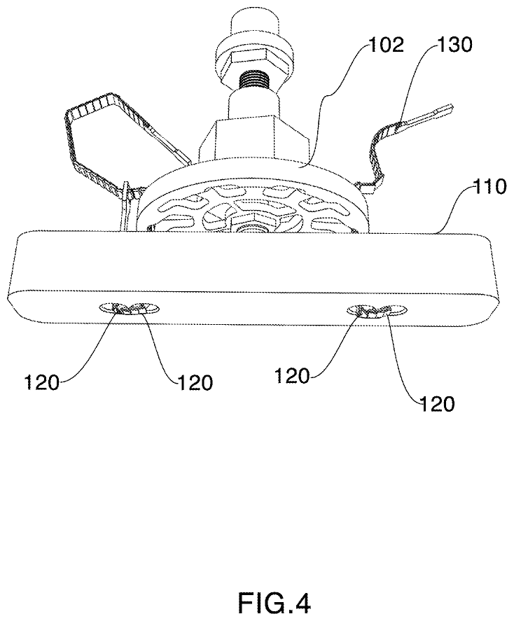

Referring now more specifically to the drawings by numerals of reference, there is shown in FIGS. 1-5, various views of a handle attachment system 100.

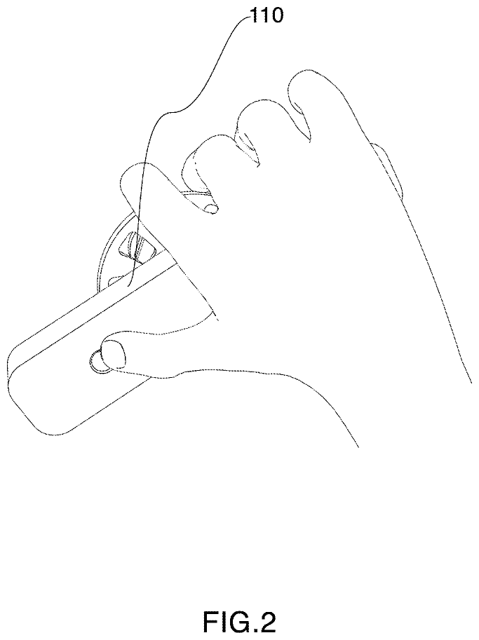

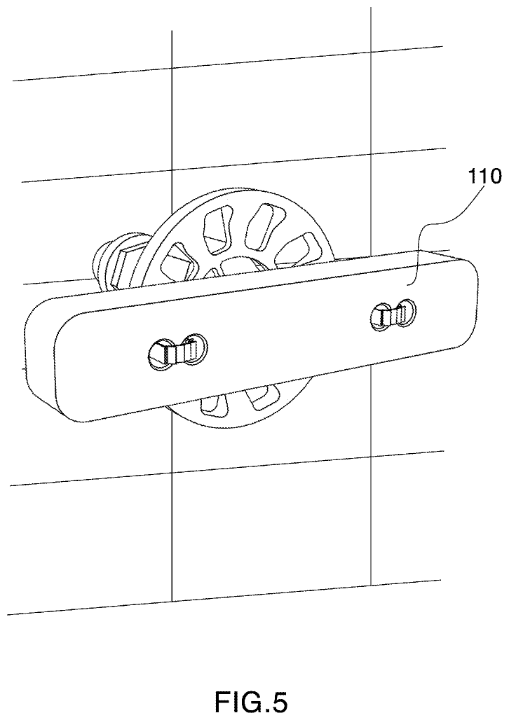

FIG. 2 shows a handle attachment system 100 during an ‘in-use’ condition 50, according to an embodiment of the present disclosure. Here, the handle attachment system 100 may be beneficial for use by a user to open and close rotary valves with relative ease. FIG. 5 shows the present invention ready for use. As illustrated, the handle attachment system 100 may include a handle 110 having a body 112 with a length; a thickness; a width; and a plurality of apertures 120 (along the length and through the thickness); and an attacher 130. The handle 110 and the attacher 130 are able to be removably attachable to a rotary valve handle 102 to facilitate ease of manipulation of the rotary valve handle 102 between open and closed conditions.

For use of the handle attachment system 100 the attacher 130 is able to be fed through a corresponding one of the plurality of apertures 120 to engage with the rotary valve handle 102 such that the body 112 is able to rotationally manipulate and leverage the rotary valve handle 102 via the length of the body 112. The attacher 130 preferably comprises two of the attacher 130; wherein the attacher 130 comprises teeth, a cable, a head with a pawl; wherein the pawl engages with the teeth to fix a relative positioning as desired by the user.

A first an attacher 130 is coupled to a left side of the rotary valve handle 102 and another an attacher 130 is attached to a right side of the rotary valve handle 102 through respective apertures 120 then the device in combination with the rotary valve handle 102 are able to be rotated clockwise or counter-clockwise as desired.

The handle of the handle attachment system 100 comprises a bar wherein the bar is substantially rectangular as shown in FIGS. 1-5, and the length of the bar is greater than a diameter of the rotary valve handle 102 such that hand-gripping is able to be accomplished on both ends of the bar outside of the diameter of the rotary valve handle 102. As such, the bar is useful as a lever in relation to the rotary valve handle 102, wherein the lever preferably comprises a mass greater than that of the rotary valve handle 102. Relationally speaking the lever is parallel to the rotary valve handle 102 when used. The attacher 130 preferably comprises flexible material such as plastic or light-weight metal alloy or the like.

According to one embodiment, the handle attachment system 100 may be arranged as a kit. In particular, the handle attachment system 100 may further include a set of instructions. The instructions may detail functional relationships in relation to the structure of the handle attachment system 100 such that the handle attachment system 100 can be used, maintained, or the like, in a preferred manner.

The method for use may include one or more components or features of the handle attachment system 100 as described above. As illustrated, the method for use may include the steps of: step one, providing a handle attachment system, (the system comprising: a handle having a body with a length; a thickness; a width; and a plurality of apertures; and an attacher); step two, inserting the attacher through a respective the aperture; step three, removably coupling the body to a rotary valve handle; and step four, leveraging movement of the rotary valve handle via hand-manipulation of the body of the handle; wherein the leveraging movement is able to be done in clockwise and alternately counter-clockwise directions.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the handle attachment system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is s:

1. A handle attachment system comprising:
a handle having
a body with
a length;
a thickness;
a width;
and
apertures;
and
an attacher,
wherein the handle and the attacher are removably attachable to a rotary valve handle,
and
wherein the attacher feeds through one of the apertures to engage the rotary valve handle such that the body rotationally manipulates and leverages the rotary valve handle.

2. The handle attachment system of claim 1, further comprising another attacher.

3. The handle attachment system of claim 2, wherein the attacher comprises a cable tie.

4. The handle attachment system of claim 2, wherein the attacher comprises cord.

5. The handle attachment system of claim 2, wherein the attacher comprises a bolt.

6. The handle attachment system of claim 2, wherein the attacher comprises a clamp.

7. The handle attachment system of claim 2, wherein the attacher comprises a bracket.

8. The handle attachment system of claim 3 wherein a first attacher connects to a left side of the rotary valve handle and another attacher connects to a right side of the rotary valve handle through the apertures.

9. The handle attachment system of claim 1, wherein the handle comprises a bar.

10. The handle attachment system of claim 9, wherein the bar is substantially rectangular.

11. The handle attachment system of claim 10, wherein the length of the bar is greater than a diameter of the rotary valve handle.

12. The handle attachment system of claim 11, further comprising handgrips on both ends of the bar.

13. The handle attachment system of claim 12, wherein the bar is useful as a lever in relation to the rotary valve handle.

14. The handle attachment system of claim 13, wherein the bar comprises a mass greater than that of the rotary valve handle.

15. The handle attachment system of claim 14, wherein the bar is parallel to a face of the rotary valve handle when attached.

16. The handle attachment system of claim 1, wherein the attacher comprises flexible material.

17. A handle attachment system, the system comprising:
a handle having
a body with
a length;
a thickness;
a width; and
a plurality of apertures;
and
two attachers,
wherein the handle and the attachers are removably attachable to a rotary valve handle, wherein the attacher comprises a flexible cable tie,
wherein the first attacher connects to a left side of the rotary valve handle and the second attacher connects to a right side of the rotary valve handle through the apertures,
wherein the handle comprises a substantially rectangular bar with rounded ends, with a length greater than the diameter of the rotary valve handle, and with handgrips on both ends of the bar,
wherein the bar has a mass greater than that of the rotary valve handle;
and
wherein the bar is parallel to the rotary valve handle when attached.

18. The handle attachment system of claim 17, further comprising set of instructions; and
wherein the handle attachment system is arranged as a kit.

19. A method of use of the handle attachment system comprising the steps of:
providing the handle attachment system of claim 1;
attaching the handle to the body of a rotary valve handle;
and
manipulating the rotary valve.

20. The method of claim 19, wherein manipulating the rotary valve includes rotating the rotary valve clockwise or counter-clockwise.
